(19) United States
(12) Patent Application Publication
(10) Pub. No.: US 2002/0185777 A1
(43) Pub. Date: Dec. 12, 2002

(54) Modular lay-up mold for a composite article and method of manufacture therefor

(76) Inventors: John R. Boath, Shelton, CT (US); Dominick N. Violano JR., Beacon Falls, CT (US); Douglas J. Kendler, Monroe, CT (US); Mark w. Rowland, Hamden, CT (US)

Correspondence Address: CARLSON, GASKEY & OLDS, P.C., 400 WEST MAPLE ROAD, SUITE 350, BIRMINGHAM, MI, 48009, US

(21) Appl. No.: 09/877,938

(22) Filed: Jun. 8, 2001

(51) Int. Cl. B29C 70/30

(52) U.S. Cl. 264/250; 264/258; 249/160; 249/139

(57) ABSTRACT

A modular mold assembly according to the present invention provides a modular exposed surface, which provides a layup surface which receives uncured prepreg composite material layers. In one orientation, the mold portions are mountable to each other and to a mold base such that the exposed surfaces define a continuos substantially U-shaped layup surface. In another assembly orientation secondary engagement surface are mated such that a substantially curved layup is formed from the exposed surface. In yet another mold assembly orientation, a mold support surface is mounted to a subset of the mold portions such that another layup surface is formed for composite components which require an extended portion. Guide outlines are provided within the exposed surface in predetermined areas as locators for a plurality of composite material layers which form a panel which is smaller than the exposed surface.

### BACKGROUND OF THE INVENTION

This invention was made with government support under Contract No.: M6784-99-C-2081 awarded by the United States Marine Corp and continued by the Department of the Army. The government therefore has certain rights in this invention.

The present invention relates to a composite pre-preg mold assembly, and more particularly to a modular mold assembly which provides for the layup of a multiple of parts.

Articles fabricated from fiber reinforced resin matrix composite materials are known, and have found increasing use in load bearing structural applications due to their high strength, light weight, and ability to be fashioned into complex shapes. Such composite structural materials are particularly suitable for aircraft structures.

One technique for manufacturing composite components includes prepreg lay-up of composite material layers. A composite component is formed from a substrate material having a plurality of parallel fibers that are saturated in a resinous material. The saturated fibers form a pre-impregnated (prepreg) material. The resulting impregnated substrate is considered a B-staged ply, ready for assembly (“lay up”) into a laminate to be cured into a structural composite material.

Prepregs have little structuaral rigidity in their uncured state and must be hand-stacked and interleaved in a mold. The mold is then placed in an autoclave oven for application of heat and pressure such that the lay-up cures into the finished composite component. As the mold forms the final shape or the composite component, dedicated molds are provided for the manufacture of each composite component. This process is extremely time and labor intensive.

Accordingly, it is desirable to provide a method facilitating the manufacture of a composite structure which provides for the manufacture of a plurality of composite components from a minimal number of molds.

### SUMMARY OF THE INVENTION

A modular mold assembly according to the present invention provides a modular exposed surface which provides a “layup” or work surface which receives the uncured prepreg composite material layers. In one orientation, the mold portions are mountable to each other and to a mold base such that the exposed surfaces define a continues substantially U-shaped layup surface. In another assembly orientation, secondary engagement surface are mated such that a substantially curved layup surface is formed by the exposed surface.

Guide outlines such as scribe lines, are provided within the exposed surface in predetermined areas as locators for a plurality of composite material layers which form the desired panel. The orientation and outer perimeter of the exposed surfaces provide another guide or alignment cue to assure that the composite material layers are properly located for formation of another finished panel. The guide outlines represent an area of the exposed surface and are preferably provided for the formation of access panels or the like which will fit into the components defined by the outer perimeter of the exposed surface. As the access panels are formed upon the exact same mold portions as the larger panel portions, a proper matched contour is assured.

In yet another mold assembly orientation, a mold support surface is mounted to a subset of the mold portions such that another layup surface is formed for the layup of composite material layers which require an extended panel interface.

The present invention therefore provides a method facilitating the manufacture of a composite structure which provides for the manufacture of a plurality of composite components from a minimal number of modular mold portions.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general exploded perspective view of a composite structure;

FIG. 2A is a schematic exploded representation of a plurality of modular mold portions arranged in one orientation;

FIG. 2B is a schematic exploded representation of the plurality of modular mold portions arranged in another orientation;

FIG. 2C is a schematic exploded representation of the plurality of modular mold portions arranged in another orientation;

FIG. 2D is a schematic exploded representation of the plurality of modular mold portions arranged in another orientation;

FIG. 3 is an expanded view of the plurality of modular mold portions arranged to form an upper panel;

FIG. 4 is an expanded view of the plurality of modular mold portions arranged to form a lower panel;

FIG. 5 is an expanded view of a first subset of the plurality of modular mold portions arranged to form an intermediate panel;

FIG. 6 is an expanded view of a second subset of the plurality of modular mold portions arranged to form an intermediate panel; and

FIG. 7 is an expanded view of the second subset of FIG. 6 and a mold support surface attached thereto to form a panel having an extended surface.

### DETAILED DESCRIPTION OF THE PREFERRED EMBODIMENT

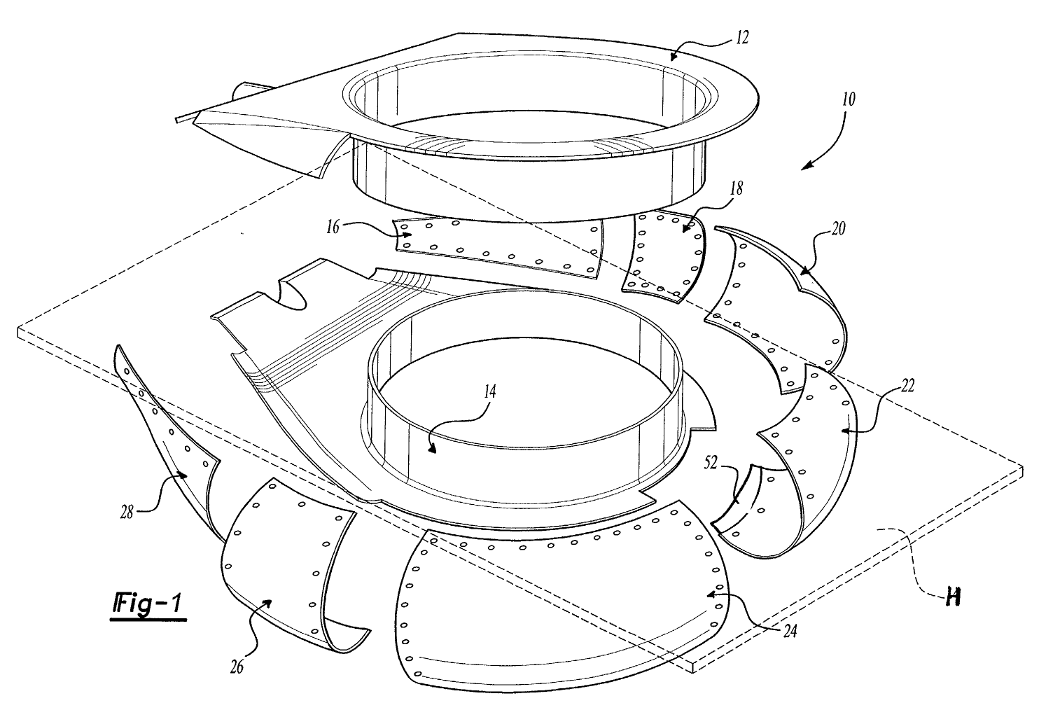

FIG. 1 illustrates an exploded view of a composite structure 10 having a plurality of composite component panels or “skins”. An upper panel 12 is joined to a lower panel 14 by a multiple of intermediate panels 16-28. Each panel 12-28 is manufactured from a plurality of prepreg composite material layers which are selectively arranged upon a layup surface to achieve the desired composite component size, shape and strength. The actual lay-up of one or more prepreg layers is well known and further description of the details thereof need not be provided herein.

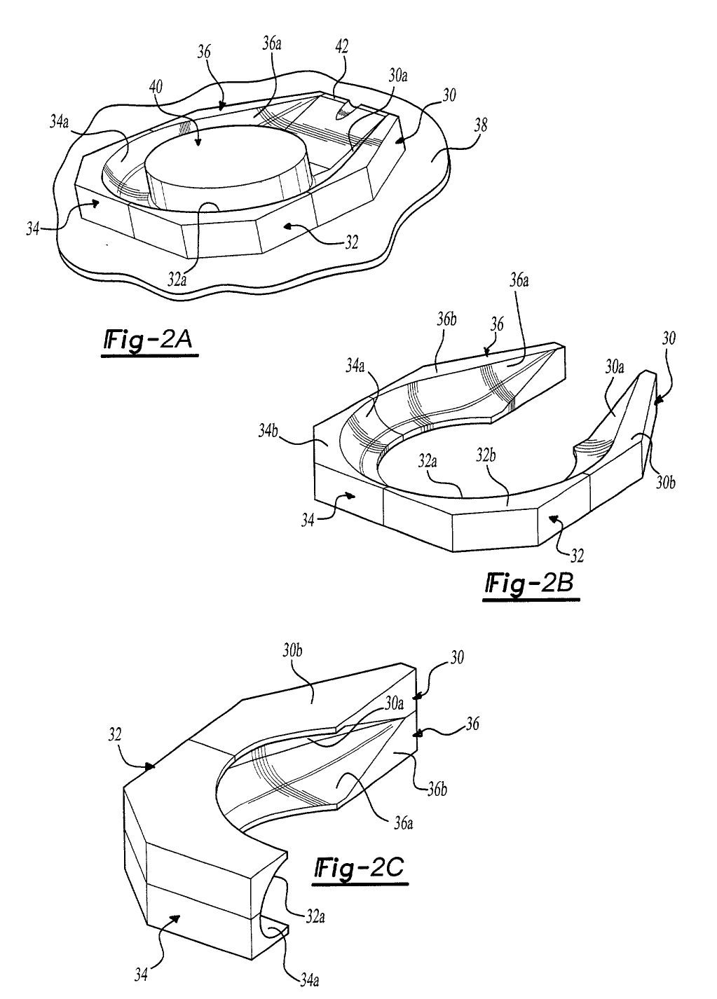

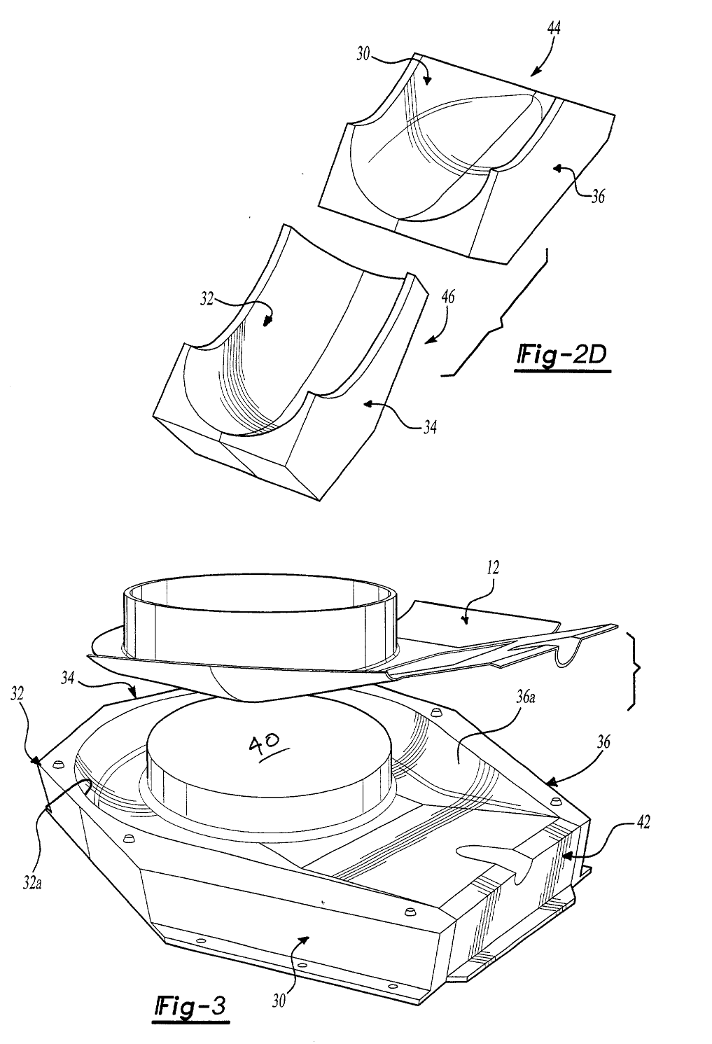

Referring to FIG. 2A, an exploded representation of a plurality of modular mold portions 30-36 are illustrated. Each mold portion includes an exposed surface 30a-36a which provides a “layup” or work surface which receives the uncured prepreg material (not shown). As is known, the lay-up surface is particularly tailored to define the finished component and further description of the details thereof need not be provided herein. Preferably, a rear left mold portion 30 is mountable to a front left mold portion 32 which is mountable to a front right mold portion 34 which is mountable to a rear right mold portion 36. It should be understood that the terms “front”, “rear” “right”, and “left” are provided for clarity of discussion and should not be considered limiting.

The mold portions 30-36 are preferably mountable to each other and to a mold base 38 such that the exposed surfaces 30a-36a define a continuos substantially U-shaped layup surface (also illustrated in FIG. 2B). Each mold portions is preferably mountable to other mold portions and to the mold base 38 by threaded fasteners such as bolts or the like, however, other fastening arrangements such as pins and locks will also benefit from the present invention.

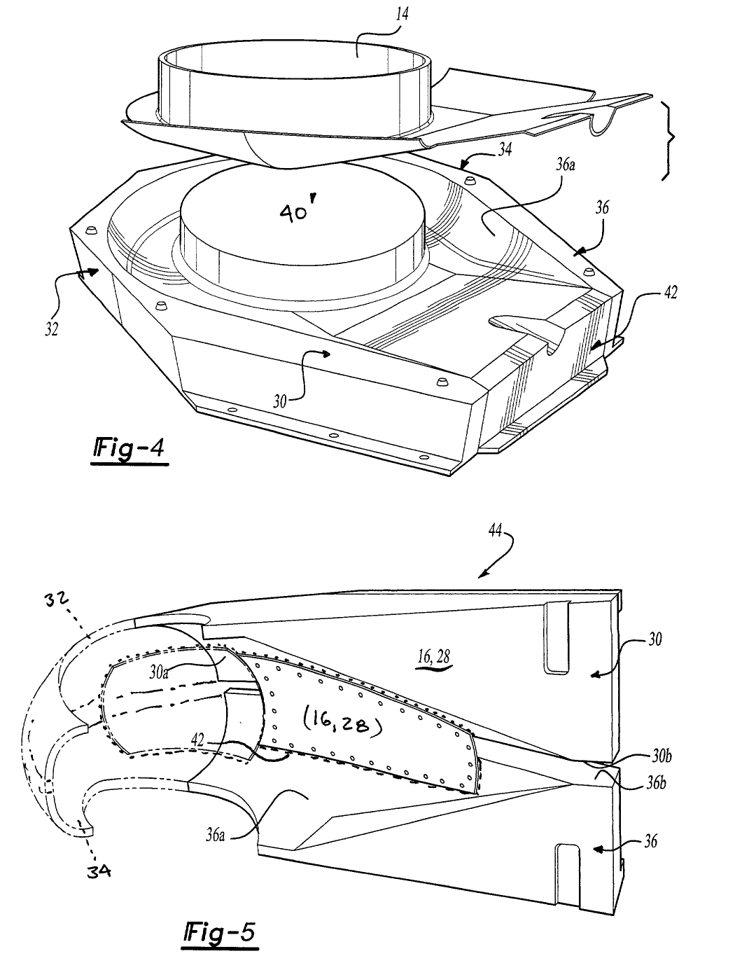

In one assembly orientation, the U-shaped layup surface formed by mold portions 30-36 and mold base 38 receive a cylindrical center mold portion 40 and a center filler extension 42. This assembly orientation provides a composite mold assembly to form the upper panel 12 (FIG. 3). By replacing the cylindrical center mold portion 40 with a second cylindrical center mold portion 40′ another composite mold assembly is provided to form the lower panel 14 (FIG. 4). The composite structure 10 (FIG. 1) illustrated in the disclosed embodiment is substantially symmetrical along a horizontal plane H (FIG. 1), however, the methodology of the present invention may be applied to other composite structures.

Referring to FIG. 2C, another assembly orientation of the modular mold portions 30-36 is illustrated. The rear left mold portion 30 is mounted to the rear right mold portion 36 and to the front left mold portion 32. The front left mold portion 32 is also mounted to the front right mold portion 34 and the rear left mold portion 30. In other words, secondary engagement surface 30b-36b (top surfaces in FIG. 2B) are the mating surfaces. The exposed surfaces 30a-36a are thus arranged to define a substantially curved layup surface which defines the area between the upper panel 12 and lower panel 14. Further, the lay-up surface is substantially arcuate in cross-section (FIG. 2D).

In the FIG. 2C orientation, a second layup surface defined by exposed surface 30a-36a are provide to form left and right aft access panels 16, 28 (FIG. 1). Preferably, guide outlines 42 such as scribe lines, are provided within the exposed surface 30a-36a in a predetermined area as a locator for a plurality of composite material layers which form the desired panel (FIG. 5). FIG. 5 illustrates an access panel formed by only the rear right 36 and rear left 30 mold portions while the FIG. 2C orientation including mold portions 30-36 will provide a layup surface which will provide an extended panel, i.e., an panel which, for example, is an integral panel combining both aft panel and intermediates panel 16, 18 and 26,28 (FIG. 1).

The orientation and outer perimeter of the exposed surfaces 30a-36a provide one guide or alignment cue to assure that the composite material layers are located for form the finished panel. In other words, the composite material layers would extend over the entire exposed surface and the edges of the exposed surface provide for the alignment of the composite materials layers. That is the edge of the exposed surfaces are the guide outlines.

The guide outlines 42 are located within the outer perimeter of the exposed surface 30a-36a to assure that the composite material layers are properly located to form the finished panels. Typically the outlines 42 represent a predetermined area of the exposed surfaces and are preferably provided for the formation of access panels or the like which will fit into the components defined by the outer perimeter of the exposed surface 30a-36a. As the access panel panels are formed by the exact same mold portions as the larger panel portions, a proper matched contour is assured.

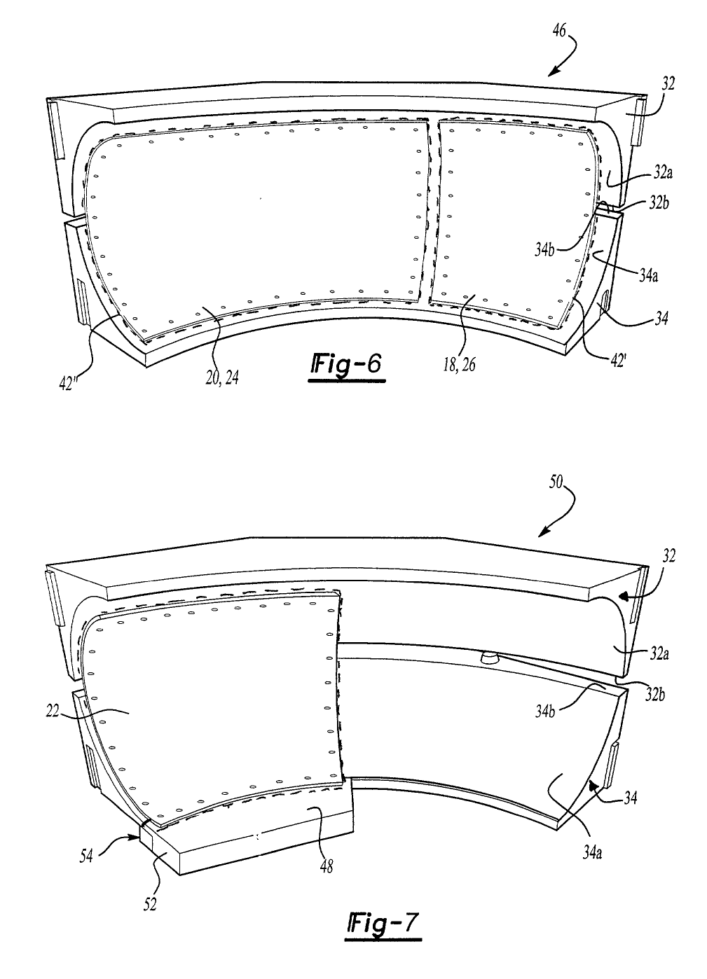

Referring to FIG. 2D, the rear left mold portion 30 and rear right mold portion 36 are separated as a first subset 44 (FIG. 5) from the second subset 46 defined by the front left mold portion 32 and front right mold portion 34 (FIG. 6). The FIG. 6 subset of the front left mold portion 32 and front right mold portion 34 are now arranged such that their exposed surfaces 32a, 34a provide a layup surface for the intermediate panels 18,20,24, and 26 (FIG. 1). Preferably, guide outline 42′, 42″ assure that the composite material layers are properly located for forming the finished intermediate panels as described above.

Referring to FIG. 7, a mold support surface 48 is mounted to the second subset 46 (FIG. 6) to define a third subset 50. The mold support surface extends the front right mold portion 34 exposed surface 34a such that another layup surface is formed for the layup of the composite material layers which form the front panel 22 (FIG. 1). Notably, the front panel 22 includes a lip 52 which fits into the lower panel 14 thus requiring the mold support surface 48. The mold support surface 48 is preferably mountable to the front right mold portion 34 by fasteners 54 or the like. Other extensions will also benefit from the present invention such that key-lock and other panel interfaces such as corresponding steps may also be provided.

It should be understood that although a composite aircraft assembly is illustrated in the disclosed embodiment, other composite structures will also benefit from the present invention. The instant invention is particularly applicable to substantially symmetrical composite structures, however, many composite structures which require a composite component having an access panel will also benefit herefrom.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A modular mold assembly for producing a plurality of composite components comprising:
a first mold portion having a first exposed surface; and
a second mold portion having a second exposed surface;
said second mold portion mountable to said first mold portion in a first orientation such that said first and second exposed surface define a first layup surface,
said first layup surface arranged to receive a first plurality of composite material layers which extends over a first predefined area of said first layup surface, and
said second mold portion mountable to said first mold portion in a second orientation such that said first and second exposed surface define a second layup surface, and
said second layup surface arranged to receive a second plurality of composite material layers which extend over a second predefined area of said second layup surface.

2. The modular mold assembly as recited in claim 1, wherein said first predetermined area is defined by said first and said second exposed surfaces.

3. The modular mold assembly as recited in claim 1, wherein said second predetermined area is defined by an outline extending within said first and second exposed surface.

4. The modular mold assembly as recited in claim 3, wherein said second predetermined area is defined by said first and second exposed surface.

5. The modular mold assembly as recited in claim 1, further including a mold base mountable to said first and second mold portion.

6. The modular mold assembly as recited in claim 1, further including a mold support surface mountable to said first portion in said second orientation to extend said first exposed surface to define a third layup surface and to receive a third plurality of composite material layers.

7. A modular mold assembly for producing a plurality of composite components comprising:
a front right mold portion having a first exposed surface and a second mating surface; and
a front left mold portion having a second exposed surface, said front left mold portion selectively mountable to either of said front right mold portion and said second mating surface of said front right mold portion;
a rear right mold portion having a third exposed surface and a second mating surface, said rear right mold portion selectively mountable to either of said front right mold portion; and
a rear left mold portion having a forth exposed surface, said rear left mold portion selectively mountable to either of said front left mold portion and said second mating surface of said right rear mold portion.

8. The modular mold assembly as recited in claim 7, wherein said rear left mold portion is mountable to said front left mold portion, said front left mold portion is mountable to said front right mold portion, and said front right mold portion is mountable to said rear right old portion such that said first, second, third, and forth exposed surface define a continuos substantially U-shaped layup surface.

9. The modular mold assembly as recited in claim 8, wherein said substantially U-shaped layup surface is at least partially arcuate in cross section.

10. The modular mold assembly as recited in claim 7, wherein said front left mold portion is mountable to said front right mold portion at said second mating surface such that said first and second exposed surfaces define a substantially curved layup surface.

11. The modular mold assembly as recited in claim 10, wherein said substantially curved layup surface is at least partially arcuate in cross section.

12. The modular mold assembly as recited in claim 10, further including a mold support mountable to said front left mold portion to extend said layup surface.

13. The modular mold assembly as recited in claim 7, wherein said rear left mold portion is mountable to said rear right mold portion at said second mating surface such that said third, and forth exposed surface define a substantially curved layup surface.

14. The modular mold assembly as recited in claim 13, wherein said substantially curved layup surface is at least partially arcuate in cross section.

15. A method of producing a plurality of composite components comprising the steps of:
(1) providing a mold assembly having a plurality of mold portions having respective exposed surfaces for receiving two pluralities of composite material layers;
(2) assembling the plurality of mold portions in a first predetermined arrangement to define a first layup surface;
(3) laying up a first plurality of composite material layers which extends over a first predefined area of said first layup surface of said first predetermined arrangement;
(4) curing said first plurality of composite material layers to form a first composite component;
(5) removing said first composite component;
(6) assembling a fist subset of the plurality mold portions in a second predetermined arrangement to define a second layup surface;
(6) receiving a second plurality of composite material layers which extend over a second predefined area of said second layup surface; and
(7) curing said second plurality of composite material layers to form a second composite component.

16. A method as recited in claim 15, further including the steps of:
assembling a second subset of the plurality mold portions in a third predetermined arrangement to define a third layup surface;
receiving a third plurality of composite material layers which extends over a third predefined area of said third layup surface; and
curing said third plurality of composite material layers to form a third composite component.

17. A method as recited in claim 16, wherein said third layup surface includes a portion of said second layup surface.
